(19) United States
(12) Patent Application Publication
(10) Pub. No.: US 2004/0216681 A1
(43) Pub. Date: Nov. 4, 2004

(54) Animal feeder

(76) Inventor: Vernon Hayes Lesher, Grants Pass, OR (US)

Correspondence Address: KOLISCH HARTWELL, P.C., 520 S.W. YAMHILL STREET, SUITE 200, PORTLAND, OR, 97204, US

(21) Appl. No.: 10/822,206

(22) Filed: Apr. 8, 2004

Related U.S. Application Data
(60) Provisional application No. 60/461,032, filed on Apr. 8, 2003.

(51) Int. Cl. A01K 1/10

(52) U.S. Cl. 119/51.13

(57) ABSTRACT

An animal feeder is provided, such feeder including a storage area disposed adjacent a feed area so as to accommodate periodic release of animal feed to the feed area. One or more feed bins may be provided, each including a shelf configured to contain feed. Each shelf may be selectively supported in a feed-containing orientation by a movable shelf support. Upon moving the shelf support, the shelf is allowed to pivot to a feed-releasing orientation, thus directing feed from the shelf to the feed area. A controller directs movement of the shelf supports according to a selected feed schedule, thereby providing for pivot of the shelves and corresponding release of feed at specified times and in quantities determined by the amount of feed contained by each shelf.

### CROSS-REFERENCE

The present application claims domestic priority under 35 U.S.C. § 119 to U.S. provisional patent application serial No. 60/461,032, filed Apr. 8, 2003, and is hereby incorporated by reference in its entirety for all purposes.

### FIELD OF THE INVENTION

The present disclosure relates generally to systems for feeding animals, and more specifically, to an animal feeder configured to effect multiple scheduled feedings.

### BACKGROUND

People raise many types of animals under a variety of circumstances and for a variety of reasons. For example, ranchers, farmers, and agri-businessmen can care for hundreds of animals (horses, cows, pigs, etc.), all requiring constant care. Anyone that has tried to raise an animal of any kind will recognize that one of the most disruptive responsibilities of a care-giver involves the need to feed the animal. Many animals, like humans, are preferably fed according to a scheduled feeding routine, often requiring at least two feedings a day, at regular intervals. In many circumstances, the animal is unable to direst its own feeding so the care-giver must be available to provide food to the animal. For example, with larger animals, such as cows and horses, there is a long tradition of farmers rising early to feed the animals, and planning the remainder of the day around the animals' feeding schedule.

Due to the daily tasks associated with caring for animals, caregivers often find it difficult to leave their animals, even for a few days. For example, if a horse owner wants to leave town, for business or recreation, the owner must either take the horse with him (which is impossible in most situations) or find someone willing and able to take on the significant responsibilities of caring for the horse while the owner is out of town. Many animal owners find it difficult to go out of town because they are unable to find someone willing or able to care for their animals, or because of the cost of hiring a skilled care-giver.

### SUMMARY

An animal feeder is provided, the feeder having a feed storage area including one or more shelves, each selectively supported in a feed-containing orientation by a movable shelf support, and a controller configured to direct movement of each shelf support in accordance with a selected feed schedule, such movement accommodating selected release of corresponding shelves to effect delivery of feed contained by such shelves in accordance with the selected feed schedule.

### BRIEF DESCRIPTION OF THE DRAWINGS

FIG. 1 is a somewhat schematic elevational view of an animal feeder constructed in accordance with an embodiment of the invention, the depicted feeder employing a plurality of vertically-stacked feed bins, each including a pivotal shelf supported in a feed-containing orientation by a retractable shelf support.

FIG. 2 is a view similar to that shown in FIG. 1, but with the lowermost shelf support retracted to drop the corresponding shelf to a feed-releasing orientation, thereby directing feed from the lowermost shelf into a feeding trough.

FIG. 3 is a somewhat schematic elevational view of a feeder constructed in accordance with another embodiment of the invention, the feeder including a plurality of horizontally-arranged feed bins, each having a floor in the form of a pivotal shelf supported in a feed-containing orientation by a retractable shelf support.

FIG. 4 is a view similar to that shown in FIG. 3, but with a shelf support retracted to drop a corresponding shelf into a feed-releasing orientation, thereby directing feed from such shelf into a feeding trough.

### DETAILED DESCRIPTION

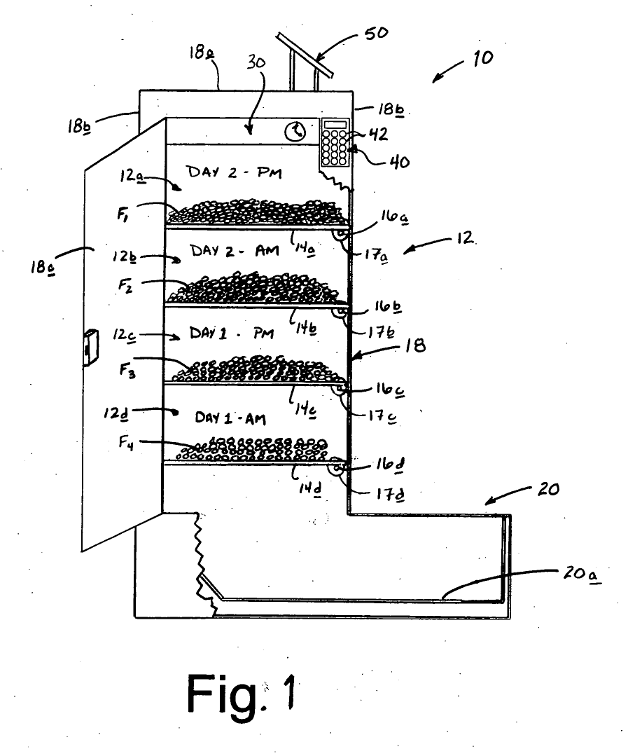

An exemplary animal feeder is shown in FIG. 1, the feeder being indicated generally at 10. As illustrated, feeder 10 includes a feed storage area 12 configured to hold one or more servings of feed (F₁, F₂, F₃, F₄) in one or more feed bins 12a-12d. Each feed bin includes a shelf, such as movable shelves 14a-14d, configured to selectively contain feed placed in the corresponding feed bin. The shelves thus may be selectively supported by movable shelf supports 16a-16d, which may take the form of retractable pins, rotary cams, or the like.

In the depicted embodiment, shelves 14a-14d are pivotally mounted within a storage housing 18 to accommodate movement of each shelf between a feed-containing orientation (wherein feed is contained by the shelf) and a feed-releasing orientation (wherein feed is released). Each shelf thus may have a first end pivotally coupled to a first wall of the housing (for example, by a hinge), and a second end releasably coupled to a second wall of the housing (for example, by a movable shelf support).

Shelves 14a-14d may further be provided with additional features to better enable them to contain feed. For example, the shelves may be provided with stiffeners to enable them to support greater weight and/or with lips, ridges, or other structural features to help maintain the feed, and when appropriate, to help dispense the feed. While the shelves may be constructed of virtually any material, a durable material that is easy to clean may be preferred.

As indicated in FIG. 1, the feed bins may be arranged vertically within storage housing 18 so as to protect the feed from the elements, as well as from animals in search of the feed. Housing 18 thus may include a closed top 18a, a plurality of closed side walls 18b, and a selectively-closable door 18c (shown open in FIG. 1), which collectively enclose feed bins from all but below the feed bins. The bottom of the housing generally remains open for reasons that will become apparent upon reading further.

Door 18c will be seen to provide access to all of the feed bins 12a-12d, allowing delivery of selected servings of feed (F₁, F₂, F₃, F₄) to each of the feed bins. Although FIG. 1 shows similar size servings in each of the feed bins, it is to be understood that differing size servings may be loaded into the feed bins to accommodate differing user-selected feed routines. Furthermore, although the feed is shown in FIG. 1 as pellets, it is to be understood that various forms of feed (e.g., hay, blocks, etc.) may be used.

It will be appreciated that the size of the feed storage bins can be varied to provide the desired volume and quantity of feedings, and that the feeder may be configured with anchors, weights, or other features to help it stay upright. Similarly, the feeder may be provided with mounting features to enable the feeder to be mounted to walls, fences, and/or other external supports.

In accordance with the present teachings, the storage housing may be placed adjacent a feed area 20, which may take the form a feed trough 20a. It will be appreciated, of course, that the feed area may take virtually any form, including for example, the underlying ground. It also will be appreciated that the feed area may be integral with housing 18, or may be a separate piece. In any event, feed area 20 is positioned to accommodate receipt of feed from the storage bins through the open bottom 18d of housing 18. Animals, in turn, may feed from the feed area upon delivery of a serving of feed thereto.

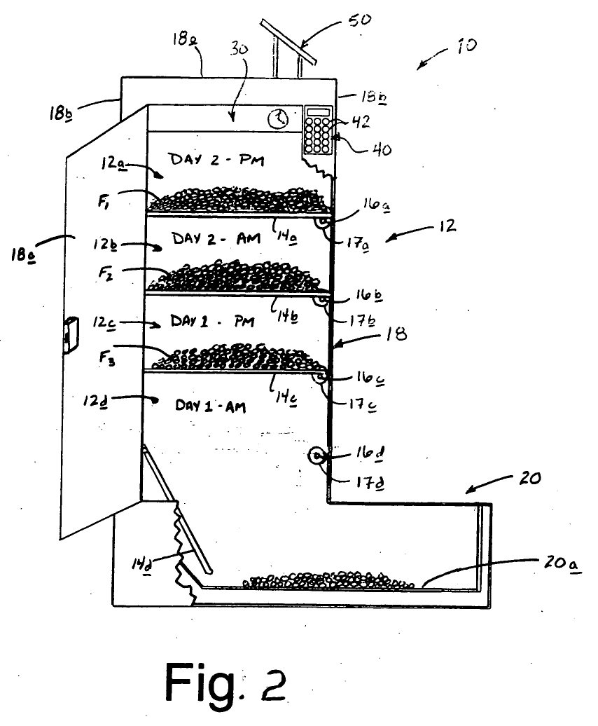

Referring now to FIG. 2, it will be noted that feeder 10 is again shown, but with a portion of the housing broken away to expose operation of movable shelves 14a-14d and of movable shelf supports 16a-16d. As indicated, the shelves may be pivotally mounted in the housing, each shelf being selectively supported in a feed-containing orientation (e.g., shelves 14a-14c) by a corresponding shelf support (e.g., shelf supports 16a-16c).

As noted previously, the shelf supports may take the form of retractable pins, such as, for example, electrically-activated pins of solenoid devices 17a-17d mounted on housing 18 in positions suitable for selectively latching shelves 14a-14d in the feed-containing orientations shown in FIG. 1. Accordingly, the solenoid devices may be powered, selectively, by a controller 30, which may be configured to operate in accordance with a desired feed routine. Typically, the solenoids are activated/de-activated in a bottom-to-top sequence so as to accommodate release of successive shelves, and thereby, to accommodate delivery of successive servings of feed.

For example, in FIG. 2, solenoid device 17d has been activated (under direction of controller 30), causing support 16d to retract, and allowing bottommost shelf 14d to pivot to the feed-releasing orientation shown. Feed thus is permitted to drop through open bottom 18d of housing 18, and to fall into trough 20a. Accordingly, animals are provided with a first serving of feed.

Although not specifically illustrated, the remaining shelves similarly may be released (in bottom-to-top order) according to a feeding routine, as directed by controller 30. Controller 30 thus may be configured to activate solenoid device 17c at a predetermined later feeding time (or at a specified time after releasing shelf 14d). Shelf support 16c thus may be caused to retract, allowing shelf 14c to pivot to a feed-releasing orientation similar to that shown in FIG. 2 for shelf 14d. As should be apparent, dropping shelf 14c will permit a second serving of feed to drop through open bottom 18d of housing 18, and to fall into trough 20a. The animals thus may be provided with a second serving of feed.

Shelves 14b and 14a similarly may be released (at later times, still under direction of controller 30) to effect delivery of further servings of feed through open bottom 18d of housing 18. More or fewer shelves may be provided to accommodate delivery of more or fewer servings of feed, but where the shelves are vertically stacked, as shown, the sequence of shelf release typically will remain bottom-to-top so as to progressively define a vertical chute through which successive servings of feed may be deployed.

As indicated in FIGS. 1 and 2, feeder 10 may be provided with a user interface 40 configured to take direction from a user and/or to provide information to a user regarding operation of the feeder. Most typically, the user interface may be used to select a feeding routine according to which controller 30 directs delivery of feed.

For example, the user interface may include a plurality of keys 42 configured to receive feeding directives from a user. These feeding directives may be provided to controller 30 for use in directing operation of solenoid devices 17a-17d, and thus for use in directing release of shelves 14a-14d.

Feeding directives may take the form of a feeding schedule which identifies times for release of shelves 14a-14d. The user interface thus may accommodate entry of plural feed times, one for each feed-containing shelf. An onboard clock (included with controller 30) may thus be employed to signal feed times, thereby directing communication of successive activation signals to successive solenoid devices (in bottom-to-top order).

Alternatively, the user interface may accommodate single-entry selection of feed times, for example, by entry of a single clock time which may be used to define feed times over several days on a repeating 12-hour clock (included with the controller). The clock may be employed to signal feed times by directing successive activation signals to successive solenoid devices (again, in bottom-to-top order).

In yet another alternative, the user interface may be nothing more than an on/off switch, which automatically activates a repeating timer (included with the controller) configured to iteratively send activation signals to successive solenoid devices (again, in bottom-to-top order) with each completion of a timer cycle.

Feeder 10 may be powered in virtually any manner, including via connection to an AC outlet, onboard solar power cells or rechargeable chemical batteries. While any type of power supply may be utilized, it may be preferred to provide a battery backup to ensure proper feeding in the event that the primary power supply fails. In FIG. 1, for example, where the feeder is powered by a solar panel 50, the solar panel may be electrically coupled to storage batteries which maintain power sufficient to operate the feeder through a feeding cycle (when the solar panel is unable to provide power, such as at night, or in stormy or overcast conditions).

In operation, a user may open housing door 18c, and place shelves 14a-14d in feed-containing orientations (shelf supports 16a-16d may be configured to yield to latch shelves in place when the shelves are pivoted to the feed-containing orientations). The user may then load a feed serving into each of the storage bins 12a-12d. As noted above, virtually any type of feed may be placed in the storage bins, including hay, alfalfa, grains, pellets, granules, etc.

After loading the storage bins, the housing door may be closed, the door typically being provided with standard closing features, including a latch to prevent access by animals in the vicinity. The user then may enter feeding directives, for example, by selecting desired feed times or feed intervals, or by simply initiating a predetermined feeding routine (which may be stored in memory associated with controller 30). Upon initiating operation of the feeder, the controller may begin polling a timer, and based on such timer, may automatically release shelves 14a-14d according to the feeding directives provided. With each shelf release, a serving of feed is delivered to a feed area for animal consumption.

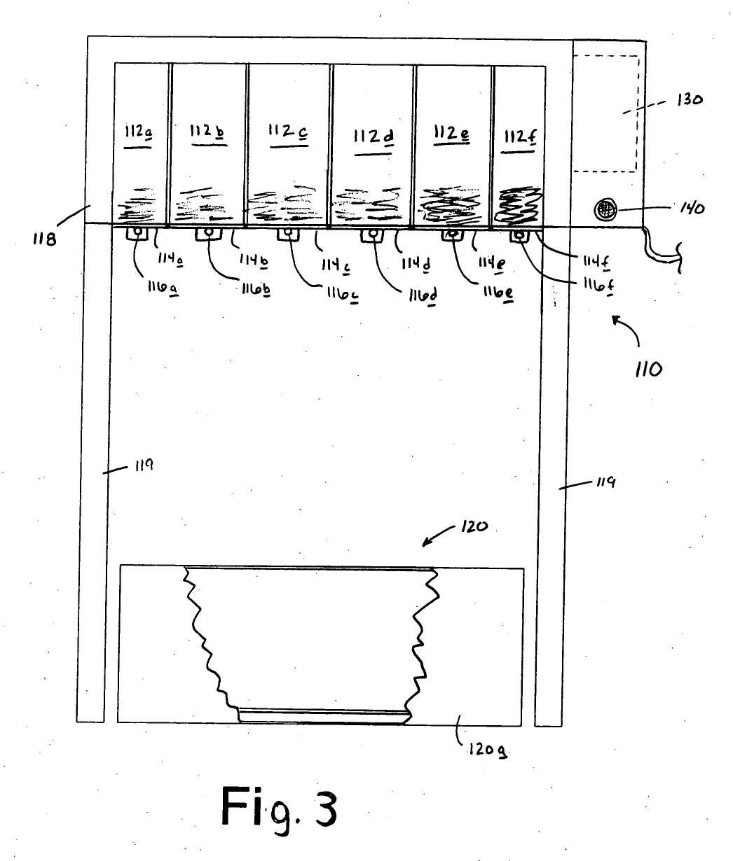

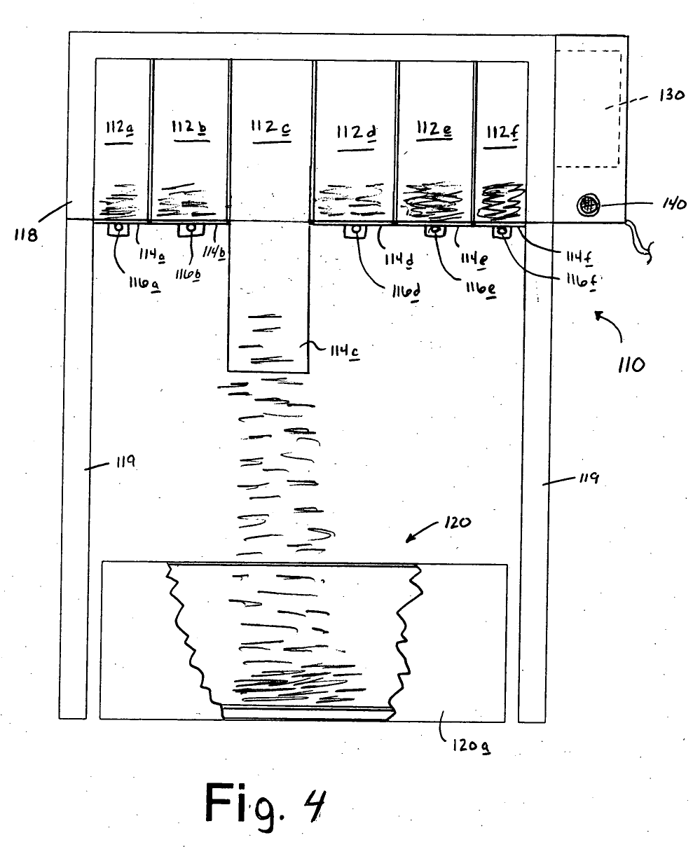

FIGS. 3 and 4 illustrate an alternative embodiment feeder 110, where similar reference numbers are used to indicate similar features. Accordingly, feeder 110 will be seen to include plural, horizontally-arranged feed bins 112a-112f, each of which has a floor in the form of a pivotal shelf 114a-114f. Shelves 114a-114f may be selectively maintained in feed-containing orientations by shelf supports 116a-116f, which are movable under direction of a controller 130 to allow corresponding shelves 114a-114f to drop to feed-releasing orientations in accordance with selected feeding directives. Feeding directives may be input by a user via a user interface 140, may be stored in memory associated with controller 130, or may be inherent in operation of a timer or the like.

As indicated, the feed bins may be contained within a housing 118, which may be supported above a feed area 120 by legs 119. In the preset illustrations, which are somewhat schematic, a housing door has been removed to illustrate the shelves 114a-114f and shelf supports 116a-116f, but it will be appreciated that the bins may be contained within the housing to protect feed from animals and the elements.

In FIG. 3, shelves 114a-114f are shown in feed-containing orientations, each supporting a serving of feed in a corresponding feed bin. In FIG. 4, one of the pivotal shelves 114c has been released, and pivoted to a feed-releasing orientation, thereby allowing a serving of feed to drop into trough 120a of feed area 120. As should be apparent, the sequencing of shelf release is flexible in the embodiment of FIGS. 3 and 4, where the feed bins are horizontally arranged.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

I claim:

1. An animal feeder comprising:
a feed storage area including one or more shelves, each selectively supported in a feed-containing orientation by a movable shelf support; and
a controller configured to direct movement of each shelf support in accordance with a selected feed schedule, such movement accommodating selected release of corresponding shelves to effect delivery of feed contained by such shelves in accordance with the selected feed schedule.

2. The animal feeder of claim 1, wherein the shelves are vertically stacked, each shelf being pivotal upon movement of a corresponding shelf support to effect release of feed contained by the shelf.

3. The animal feeder of claim 2, wherein the vertically stacked shelves are contained within an upright housing and are allowed to pivot successively, from bottom to top, to progressively define a feed chute through which released feed is delivered to a feed area below.

4. The animal feeder of claim 1, wherein each shelf support is retractable upon receipt of an signal from the controller.

5. The animal feeder of claim 1, wherein each shelf support is solenoid-activated upon receipt of a signal from the controller.

6. The animal feeder of claim 1, wherein the controller includes a clock, and the feed schedule defines a clock time for release of each shelf.

7. The animal feeder of claim 6, which further comprises a user interface, and wherein the feed schedule is entered by a user via the user interface.

8. The animal feeder of claim 1, wherein the controller includes a timer, the feed schedule being defined by a timer interval indicating time between release of shelves.

9. The animal feeder of claim 1, wherein the shelves are horizontally stacked, each shelf being pivotal upon movement of a corresponding shelf support to effect release of feed contained by the shelf.

10. An automated animal feeder, comprising:
a storage housing having a closed top and an open bottom, wherein at least a portion of the storage housing is disposed above a feed area;
a plurality of feed storage bins defined in the storage housing, each storage bin including a shelf hingedly coupled with the storage housing, the shelf having a hinged end and a free end, wherein the free end is releasable to drop feed from the shelf into the feed area;
a user interface configured to allow a user to input a feeding schedule; and
a controller configured to release each shelf according to the input feeding schedule.
